(19) United States
(12) Patent Application Publication
(10) Pub. No.: US 2021/0019710 A1
(43) Pub. Date: Jan. 21, 2021

(54) COMPUTING SYSTEM THAT IS CONFIGURED TO INFER LOCATIONS OF ENTERPRISE ROOMS

(71) Applicant: Microsoft Technology Licensing, LLC, Redmond, WA (US)

(72) Inventors: Senthil Kumar PALANISAMY, Kenmore, WA (US); Siddhartha Cingh ARORA, Redmond, WA (US); Xuanyang GE, Bellevue, WA (US)

(21) Appl. No.: 16/515,028

(22) Filed: Jul. 18, 2019

(51) Int. Cl. G06Q 10/10; G08B 21/24; H04W 4/02; H04W 4/029

(52) U.S. Cl. CPC G06Q 10/1095; H04W 4/029; H04W 4/023; G08B 21/24

(57) ABSTRACT

Described herein are various technologies pertaining to mapping a geolocation to a location string in a meeting entry of an electronic calendar of a user. Visit entries are generated based upon location entries output by a mobile computing device of the user, wherein a visit entry includes a geolocation, a start time, and an end time of a visit of the user represented by the visit entry. A determination is made that a meeting entry for the user that includes a location string temporally overlaps with the visit entry, and the geolocation of the visit entry is mapped to the location string of the meeting entry based upon the meeting entry and the visit entry temporally overlapping.

### BACKGROUND

Conventional computing systems have been configured to transmit “time to leave” (TTL) notifications to computing devices of end users, wherein the notifications include recommendations as to when the end users are to leave a current location and reach a destination location. For example, a meeting entry of an electronic calendar application of a user may include a start time of a meeting, an end time of the meeting, and a location (e.g., a street address and/or latitude/longitude coordinates) where the meeting is to be held. A computing system can receive a current location of a mobile computing device of the user and ascertain an expected amount of time required for the user to travel from the current location of the mobile computing device to the location specified in the meeting entry. Thus, based upon a current time, the current location of the mobile computing device, the start time of the meeting, the location of the meeting, and current or expected traffic conditions, the computing system can generate and transmit a TTL notification to the mobile computing device to the user, wherein such recommendation includes a time that the computing system recommends that the user begin travelling towards the location of the meeting to arrive at the meeting on time.

Some enterprises may have people located in various buildings, where the buildings may include several floors, and the floors may have several rooms. A meeting entry for a user in an electronic calendar application may specify, as a location of a meeting represented by the meeting entry, an identity of a building, a floor, and/or a room of the meeting. In an example, a location string in a meeting entry may be “Building 12, Conference Room 3154”. This location string does not have a geolocation associated therewith; hence, a mapping application provided with the location string is unable to present directions to the meeting location without additional information. Thus, a computing system that is configured go generate TTL notifications is often unable to generate such notifications with respect to meeting entries generated through use of an enterprise electronic calendar application.

### SUMMARY

The following is a brief summary of subject matter that is described in greater detail herein. This summary is not intended to be limiting as to the scope of the claims.

Described herein are various technologies pertaining to assigning geolocation data (such as a latitude/longitude coordinates or a street address) to a meeting location string that occurs in electronic meeting requests that represent meetings, such that a computing system is able to generate “time to leave” (TTL) notifications to users who have indicated that they will attend the meetings. More specifically, with consent of a user, location entries generated by a location sensor (e.g., a global positioning system (GPS) sensor) of a mobile computing device can be received over time. A computing system processes the location entries to generate a location diary for the user, wherein the location diary comprises chronologically ordered visit entries. A visit entry represents a visit of the user to a geolocation, wherein the visit entry comprises, for example, the geolocation, a start time of the visit, and an end time of the visit.

The computing system additionally receives historic meeting entries from a calendar application of the user, wherein the meeting entries indicate that the user attended meetings represented by the meeting entries, and further wherein each of the meeting entries includes a start time, an end time, and a location string that is representative of a location of a meeting represented by the meeting entry. The computing system compares the meeting entries with the visit entries in the location diary and identifies meeting entry/visit entry pairs, wherein a visit entry and a meeting entry in a pair intersect with one another in time. Put differently, for a meeting entry, the computing system identifies a visit entry that temporally corresponds with the meeting entry, thereby ascertaining a geolocation of the user during a time of the meeting. From the foregoing, it can be ascertained that the computing system can identify several meeting entry/visit entry pairs.

The computing system aggregates visit entries for a location string extracted from one or more meeting entries, such that each location string is mapped to at least one visit entry. For instance, several meeting entries may have the same location string; each of the visit entries that temporally intersected the several meeting entries can be mapped to the location entries. Accordingly, location string “Building 12, Conference Room 3154” may have several visit entries mapped thereto.

The computing system generates, for a visit entry mapped to the location string, values of a plurality of features for the visit entry and a cluster of location entries used to construct the visit entry. Exemplary feature values can include, for instance, an amount of time that the visit entry and the meeting entry overlap in time; a total number of location entries in the cluster; a number of location entries in the cluster that temporally overlap with the meeting entry; a duration of time of the visit entry; a semantic label assigned to the visit entry (e.g., home, work, etc.); a value of a latest timestamp assigned to a location entry in the cluster; and a radius of the cluster. The computing system executes a scoring function, wherein the scoring function is provided with such values of the features for the cluster and outputs a score that is indicative of a confidence that a geolocation of the visit entry corresponds to the location string. The computing system compares the score to a predefined threshold, and when the score is above the threshold, the computing system maps the geolocation of the visit entry to the location string of the meeting entry in computer-readable storage for the user. Hence, when the electronic calendar application of the user includes a future meeting entry that comprises the location string as a location of a meeting represented by the meeting entry, the computing system can assign, to the meeting entry, the geolocation that is mapped to the location string. Thereafter, the computing system can generate a TTL notification and transmit the TTL notification to a computing device of the user based upon a current location of the user and the geolocation that is assigned to the meeting entry.

The above process describes mapping a geolocation to a location string for an individual user. Aspects described herein also relate to global assignation of a geolocation to a location string in an enterprise directory, such that each meeting entry (in an enterprise electronic calendar application) that includes the location string can be assigned the geolocation. With more particularity, the computing system can repeat the process described above for several users, such that location strings in meeting entries of the users can be mapped to geolocations for such users. The computing system can receive these user-specific mappings, and can globally assign a geolocation to a location string based upon the user-specific mappings. For instance, with respect to a location string, the computing system can receive several observations, wherein each observation can include: 1) a user identifier; 2) the location string; and 3) a geolocation mapped to the location string for a user identified by the user identifier. In an exemplary embodiment, the computing system can cluster the observations into one or more clusters, and the computing system can assign a score to each cluster, wherein the score is indicative of a confidence that a geolocation represented by the cluster should be globally assigned to the location string in the enterprise directory. When the scores above a threshold, the computing system assigns the geolocation to the location string in the enterprise directory. Subsequently, the computing system can assign the geolocation to each meeting entry in the enterprise electronic calendar application across all users in the enterprise.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that is configured to map a geolocation to a location string, such that the geolocation can be assigned to a meeting entry that includes the location string.

FIG. 2 is a schematic that depicts generation of a location diary for a user.

FIG. 3 is a schematic that illustrates processing of a meeting entry of an electronic calendar application.

FIG. 4 is a schematic that illustrates identifying visit entries of a location diary of a user that temporally intersect meeting entries of an electronic calendar application of the user.

FIG. 5 is a functional block diagram of a scorer module that is configured to assign a score to a cluster of location entries, wherein the score is indicative of a confidence that a geolocation for the cluster is to be assigned to a location string in a meeting entry.

FIG. 6 is a functional block diagram of an exemplary system that is configured to assign a geolocation to a location string in an enterprise directory, such that meeting entries for an enterprise electronic calendar application that include the location string are assigned the geolocation.

FIG. 7 is a flow diagram that illustrates an exemplary methodology for mapping a geolocation to a location string, wherein the location string is extracted from a meeting entry of an electronic calendar application.

FIG. 8 is a flow diagram illustrating an exemplary methodology for assigning a geolocation to a location string in an enterprise directory.

FIG. 9 is an exemplary computing system.

### DETAILED DESCRIPTION

Various technologies pertaining to inferring a geolocation to map to a location string extracted from a meeting entry of an electronic calendar application are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Described herein are various technologies pertaining to mapping a geolocation, such as latitude/longitude coordinates or a street address, to a location string extracted from a meeting entry of an electronic calendar application. Electronic calendar applications can be used to schedule meetings, wherein a meeting entry generated by way of an electronic calendar entry includes: identities of invitees to a meeting represented by the meeting entry, an identity of an organizer of the meeting, a start time of the meeting, an end time of the meeting, and (optionally) a location string that identifies a location of the meeting. In enterprises, particularly relatively large enterprises that have multiple buildings, meeting entries generated by way of electronic calendar applications often include location strings that identify a room in a building in an enterprise. For instance, a location string may be a name of a building and/or conference room, such as “Building 12, Conference Room 3154.” The location string, however, fails to include a geolocation; accordingly, a computer-executable mapping application is unable to ascertain the location of the conference room identified in the location string, and thus is unable to ascertain the location of the meeting represented by the meeting entry.

The technologies described herein relate to a computing system that is configured to infer a geolocation for a location string based upon location entries generated by a mobile computing device of a user. The technologies described herein also relate to a computing system that is configured to assign a geolocation to a location string in an enterprise directory, such that meeting entries that include the location string are assigned the geolocation, wherein the meeting entries are generated by an electronic calendar application utilized in an enterprise. With more particularity, the computing system described herein can access a historic meeting entry for a user, wherein the meeting entry indicates that the user attended a meeting represented by the meeting request, and further wherein the meeting entry includes a location string that identifies a location of the meeting. The computing system, based upon location entries generated by a mobile computing device of the user, can additionally ascertain a geolocation of the user during a time of the meeting. Based upon the identified location of the user during the meeting, the computing system can map the geolocation to the location string. Accordingly, for a meeting entry that represents a meeting that is to be held in the future, wherein the meeting entry includes the location string, the geolocation can be assigned to such meeting entry. Thus, the computing system can generate TTL notification and transmit the TTL notification to the mobile computing device of the user, wherein the TTL notification includes a recommendation as to a time that the user is to leave his or her current location to reach the meeting at a time that the meeting is scheduled to start.

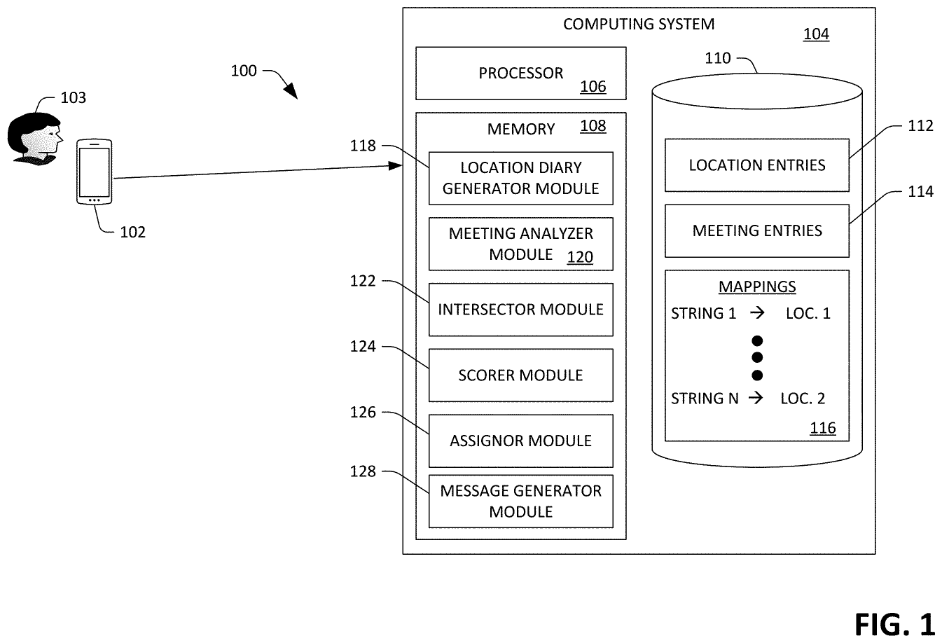

With reference now to FIG. 1, an exemplary system 100 that facilitates mapping a geolocation to a location string extracted from a meeting entry of an electronic calendar application is illustrated. The system 100 includes a mobile computing device 102 of a user 103, wherein the mobile computing device 102 may be a tablet computing device, a mobile telephone, a wearable computing device (such as a watch, glasses, fitness band, etc.). The system 100 additionally includes a computing system 104 that is in communication with the mobile computing device 102 by way of a suitable network. The mobile computing device 102 has a location sensor (not shown) therein that generates location entries that are indicative of locations of the mobile computing device 102 over time. A location entry generated by the mobile computing device 102 can include, but is not limited to including, an identifier of the user 103 of the mobile computing device 102 (wherein the identifier can be anonymized), a latitude/longitude coordinate pair, and a timestamp that identifies when the mobile computing device 102 generated the location entry (and therefore identifies when the user 103 was at the location represented by the latitude/longitude coordinate pair).

The mobile computing device 102 is configured to report location entries to the computing system 104 over time. In an example, the mobile computing device 102 can periodically report location entries to the computing system 104. In another example, the mobile computing device 102 can report location entries to the computing system 104 when the mobile computing device 102 detects that the mobile computing device 102 has moved some threshold distance where the mobile computing device 102 most recently reported a location entry. It is to be understood that the mobile computing device 102 does not report location entries when the mobile computing device 102 is in a low-power mode, when the mobile computing device 102 is powered off, etc.

The computing system 104 includes a processor 106 and memory 108, wherein the memory 108 includes instructions that are executed by the processor 106. The computing system 104 also includes a data store 110. The data store 110 stores location entries 112 reported to the computing system 104 by the mobile computing device 102. The data store 110 also stores meeting entries for the user 103 of the mobile computing device 102, wherein the meeting entries 114 of an electronic calendar application, wherein the meeting entries 114 represent meetings that occurred in the past, and further wherein the meeting entries 114 indicate that the user 103 attended the meetings. A meeting entry in the meeting entries 114 that represents a meeting includes: a time and date when the meeting started; a time and date when the meeting ended; a location string that is representative of a location where the meeting occurred; an identity of an organizer of the meeting; identities of people who were invited to the meeting; identities of people who indicated that they attended the meeting; indications as to whether meeting invitees were required or optional; a subject text string that is indicative of a subject of the meeting; etc.

With more detail pertaining to a location string in a meeting entry, the location string may include a geolocation, such as a street address, latitude/longitude coordinates, etc. In another example, the location string may refer to a virtual location, thereby indicating that the meeting is an “online meeting” or a telephonic meeting. In yet another example, the location string can refer to a physical location, but lacks a geolocation for the physical location. Thus, the location string can include an identifier for a room in a building of the enterprise but may lack a street address for the building that identifies the location of the building. As will be described in greater detail below, the computing system 104 is configured to identify a geolocation that corresponds to the location string (for the user 103) and map the geolocation to the location string.

The data store 110 can also include mappings 116, wherein the mappings 116 include mappings between location strings extracted from the meeting entries 114 and geolocations that have been assigned to the location strings by the computing system 104. For example, location string 1 is mapped to a first geolocation, and location string N is mapped to a second geolocation, wherein location strings 1-N refer to physical locations but fail to include geolocations.

The memory 108 includes a location diary generator module 118 that is configured to generate a location diary for the user 103 of the mobile computing device 102 based upon the location entries 112 stored the data store 110. A location diary generated by the location diary generator module 118 can comprise a plurality of chronologically ordered visit entries, wherein each of the visit entries represents a visit of the user 103 to a respective geolocation. A visit entry in the location diary includes a start date and time, an end date and time, and a geolocation for the visit, wherein the geolocation can be latitude/longitude coordinates or a street address. As will be described in greater detail below, the location diary generator module 118 generates the location diary by clustering the location entries 112, such that a cluster of location entries comprises temporally and spatially proximate location entries. The location diary generator module 118 can ascertain a geolocation for a visit entry based upon latitude/longitude coordinate pairs of location entries in the cluster. For instance, the location diary generator module 118 can randomly select a location entry from the cluster and can assign a latitude/longitude coordinate pair of the randomly selected location entry to the visit entry. In another example, the location diary generator module 118 can identify a spatial centroid of the cluster and can assign the spatial centroid to the visit entry. In yet another example, the location diary generator module 118 can compute median or mean latitude and longitude values based upon the location entries in the cluster and can assign the median or mean latitude and longitude values to the visit entry. Optionally, the location diary generator module 118 can provide latitude/longitude coordinate pairs to a reverse geocoding service, which can return street addresses that correspond to the latitude/longitude coordinate pairs, and the location diary generator module 118 can assign a street address to the visit entry.

With respect to the start time and the end time of a visit entry, the location diary generator module 118 can identify a location entry in the cluster with an earliest timestamp and a location entry in the cluster with a latest timestamp. The location diary generator module 118 can assign the earliest timestamp as the start date and time of the visit entry and can assign the latest timestamp as the end date and time of the visit entry. Thus, the location diary generated by the location diary generator module 118 includes a chronologically ordered sequence of non-overlapping visit entries, with each visit entry representing a visit of the user 103 of the mobile computing device 102 to a respective geolocation.

The memory 108 additionally includes a meeting analyzer module 120 that filters meeting entries from the meeting entries 114 based upon locations strings of meeting entries in the meeting entries 114 and other factors pertaining to the user 103. In an example, the meeting analyzer module 120 identifies time periods from an electronic calendar application where the user 103 has indicated that the user 103 was unavailable (e.g., the electronic calendar application indicates that the user 103 was out of the office). The meeting analyzer module 120 identifies meeting entries in the meeting entries 114 that represent meetings that occurred when the user 103 has indicated that the user was unavailable and filters such meeting entries from the meeting entries 114. In another example, the meeting analyzer module 120 can select a meeting entry from the meeting entries 114 and extract a location string therefrom. The meeting analyzer module 120 can ascertain whether the location string includes a geolocation, such as an address or latitude/longitude coordinates. The meeting analyzer module 120 can filter the meeting entry from the meeting entries 114 when the location string of the meeting entry includes the geolocation. In yet another example, the meeting analyzer module 120 can ascertain whether the location string fails to include a location intent; put differently, the meeting analyzer module 120 ascertain whether the location string refers to a non-physical location, such as an online meeting or a telephone meeting. The meeting analyzer module 120 can filter the meeting entry from the meeting entries when the location string refers to a non-physical location. In still yet another example, the meeting analyzer module 120 can search the mappings 116 based upon the location string to ascertain whether a geolocation is already mapped to the location string. When the location string is already mapped to a geolocation in the mappings 116, the meeting analyzer module 120 can filter the meeting entry from the meeting entries 114. The meeting analyzer module 120 can subsequently output remaining (unfiltered) meeting entries.

The memory 108 also includes an intersector module 122 that is configured to compare the unfiltered meeting entries with the location diary to identify visit entries that intersect in time with meeting entries. Thus, the intersector module 122 can select a meeting entry (which has a start date and time and an end date and time) and identify, from the location diary, one or more visit entries that intersect with the meeting entry in time. The intersector module 122 repeats such process for each of the unfiltered meeting entries, thereby forming a list of location strings (extracted from the meeting entries), with each location string in the list having at least one visit entry assigned thereto. A location string may occur in multiple meeting entries; the intersector module 122 aggregates visit entries assigned to the location string. It is therefore to be ascertained that a location string may have several different visit entries assigned thereto, with each visit entry corresponding to a respective cluster of location entries.

The memory 108 also includes a scorer module 124 that, with respect to a location string in the list of location strings, assigns a score to a visit entry (and thus a geolocation) that is assigned to the location string. With more particularity, the scorer module 124 selects a visit entry that is assigned the location string and generates values for features of the visit entry and a cluster of location entries that correspond to the visit entry. Exemplary features include, but are not limited to: 1) an amount of time that the visit entry and a meeting entry that temporally intersects with the visit entry overlap in time; 2) a total number of location entries in the cluster; 3) a number of location entries in the cluster that temporally overlap with the meeting entry; 4) a duration of time of the visit entry; 5) a semantic label assigned to the geolocation of the visit entry (e.g., “home”, “work”, etc.); 6) a value of a latest timestamp assigned to a location entry in the cluster; and 7) a spatial radius of the cluster. The scorer module 124, based upon such feature values, outputs a score that is indicative of a confidence that the geolocation of the visit entry represents, to the user 103, a geolocation that is to be mapped to the location string in the mappings 116. In an example, the scorer module 124 can include a gradient-boosted decision tree model to generate the score, wherein the gradient-boosted decision tree model is trained based upon labeled training data. In an example, the scorer module 124 can compute a score for each visit entry assigned to the location string in the list output by the intersector module 122. In another example, the scorer module 124 can select one or more visit entries based upon one or more rules—for instance, the scorer module 124 can select a most recent visit entry and compute a score for such visit entry; the scorer module 124 can select a visit entry with a longest duration and compute a score for such visit entry, etc.

The memory 108 also includes an assignor module 126 that compares the score output by the scorer module 124 for the visit entry with a predefined threshold, and when the score is above the predefined threshold, the assignor module 126 updates the mappings 116 to include a mapping between the location string and the geolocation of the visit entry. Inclusion of a mapping between the location string and the geolocation in the mappings 116 indicates that, for the user 103, when a meeting entry includes the location string as a location of the meeting, the physical location of the meeting (for the user 103) is at the geolocation.

The memory 108 also comprises a message generator module 128 that is configured to transmit messages to computing devices of the user 103 (including the mobile computing device 102) based upon the location string being mapped to the geolocation in the mappings 116. For instance, the message generator module 128 can access meeting entries that represent meetings that occur during time windows in the future, where the user 103 of the mobile computing device 102 has been invited to such meetings (and optionally indicates that the user 103 is planning on attending the meetings). The message generator module 128 can search such meeting entries for the location string in the mappings 116. When the message generator module 128 ascertains that a meeting entry includes the location string (from the mappings 116), the message generator module 128 can assign the geolocation that is mapped to the location string in the mappings 116 to the meeting entry. The message generator module 128 can additionally receive a most recently reported location entry from the mobile computing device 102 and can transmit a TTL notification to the mobile computing device 102 (or other computing device of the user) that informs the user 103 of the mobile computing device 102 as to when the user 103 should depart from his or her current location to reach the meeting represented by the meeting entry on time. In an example, the message generator module 128 can ascertain that a meeting entry represents a meeting that is to occur in one half hour, and can further ascertain that the location string in the meeting entry is mapped to a geolocation in the mappings 116, wherein travel time between a current location of the mobile computing device 102 and the geolocation is 25 minutes. The message generator module 128 can cause a TTL notification to be transmitted to the mobile computing device 102, wherein the TTL notification informs the user 103 to depart for the meeting within the next five minutes to arrive at the meeting on time.

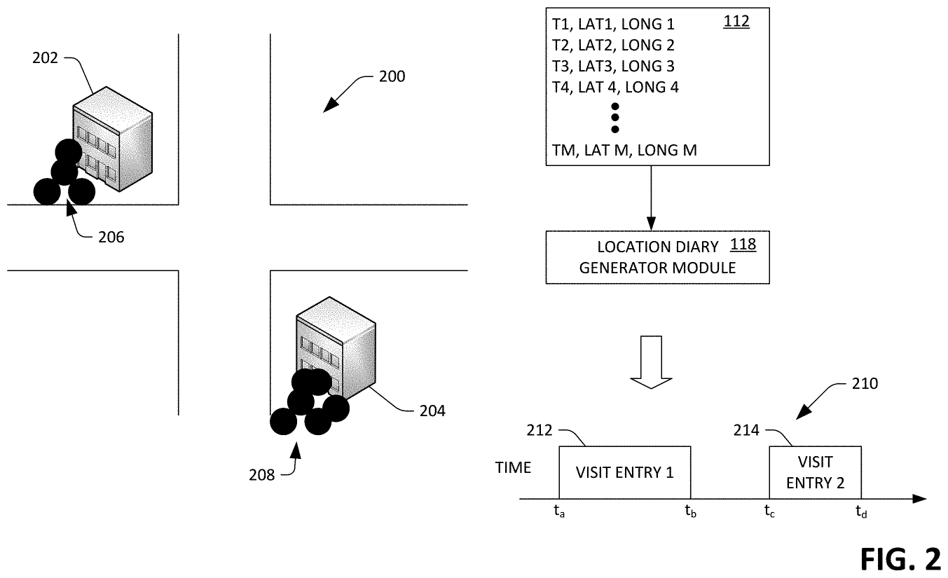

FIGS. 2-5 include schematics that illustrate exemplary operation of the computing system 104. Referring specifically to FIG. 2, a schematic that depicts exemplary operation of the location diary generator module 118 is illustrated. A geographic region 200 includes a first building 202 and a second building 204. As illustrated, the mobile computing device 102 has generated a first set of location entries 206 when the mobile computing device 102 was located in or proximate the first building 202 and has generated a second set of location entries 208 when the mobile computing device 102 was located in or proximate the second building 204.

The computing system 104 receives the location entries generated by the mobile computing device 102 over time, such that the location entries 112 include a sequence of chronologically ordered location entries. As described previously, each location entry can include a timestamp that indicates when the mobile computing device 102 generated the location entry, a latitude coordinate, and a longitude coordinate. In the schematic illustrated in FIG. 2, the location entries 112 include M location entries, with the M location entries comprising the first set of location entries 206 and the second set of location entries 208.

The location diary generator module 118 receives the location entries 112 and generates a location diary 210 based upon the location entries 112. The location diary 210 comprises a sequence of non-overlapping, chronologically ordered visit entries that represent visits of the user 103 to geolocations. In the exemplary schematic of FIG. 2, the location diary 210 includes a first visit entry 212 that corresponds to the first set of location entries 206 and a second visit entry 214 that corresponds to the second set of location entries 208, wherein the first visit entry 212 has a start time of tₐ and an end time of t_{b}, and the second visit entry 214 has a start time of t_{c} and an end time of t_{d}. When generating the location diary 210, the location diary generator module 118 can execute a clustering algorithm over the location entries 112 to generate clusters of location entries, wherein each cluster includes location entries that are spatially and temporally proximate to one another. Hence, in the example illustrated in FIG. 2, the location diary generator module 118 can cluster the location entries 112 into two clusters: a first cluster that comprises the first set of location entries 206 and a second cluster that comprises the second set of location entries 208. In an exemplary embodiment, the location diary generator module 118 can employ the DBSCAN algorithm to generate clusters of location entries with the following parameter values: a minimum number of location entries=3; epsilon=100. Location entries that do not belong to a cluster can be retained for future clustering (e.g., such location entries may be included in a suitable cluster as more location entries are received).

Further, with respect to a cluster of location entries, the location diary generator module 118 can ascertain whether a difference in time between an earliest timestamp assigned to a location entry in the cluster and a latest timestamp assigned to a location entry in the cluster is above a predefined threshold (e.g., ten minutes). When the difference in time is above the predefined threshold, the location diary generator module 118 can generate a visit entry that corresponds to the cluster, wherein the visit entry comprises a geolocation (which is based upon geolocations of location entries of the cluster), a start time and date, and an end time and date, and optionally the location entries in the cluster. Alternatively, the location entries in the cluster can be indexed to the visit entry. Accordingly, the t_{b}-tₒ can be greater than the predefined threshold, and the first visit entry 212 can comprise the first set of location entries 206. Similarly, t_{d}-t_{c} can be greater than the predefined threshold, and the second visit entry 214 can comprise the second set of location entries 208.

The visit entries 212 and 214 can also include respective geolocations, wherein the location diary generator module 118 determines the geolocations based upon the location entries in the clusters mentioned above. For example, the location diary generator module 118 can determine a first geolocation for the first visit entry based upon latitude/longitude coordinate values of location entries in the cluster that comprises the first set of location entries 206. The first geolocation can be a spatial centroid of the location entries in the cluster, median latitude/longitude values of the location entries in the cluster, a street address provided by a reverse geocoding service, etc. The location diary generator module 118 can determine a second geolocation for the second visit entry based upon latitude/longitude coordinate values of locations entries in the cluster that comprises the second set of location entries 208.

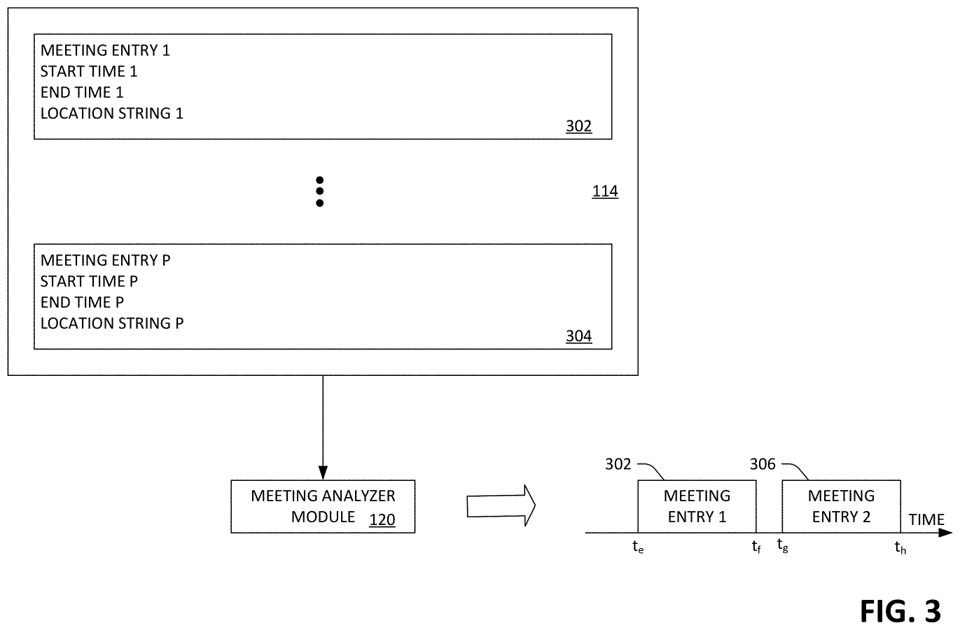

Referring now to FIG. 3, a schematic that depicts operation of the meeting analyzer module 120 is depicted. The meeting analyzer module 120 receives the meeting entries 114, wherein the meeting entries 114 include several meeting entries 302-304 from an electronic calendar application of the user 103, wherein the meeting entries 302-304 represent meetings that occurred in the past. Each of the meeting entries 302-304 includes, but is not limited to including, a start time, an end time, and a location string that describes a location of the meeting.

The meeting analyzer module 120 access data from the electronic calendar application of the user 103 to ascertain windows of time when the user 103 indicated that he or she was unavailable (e.g., out of the office). The meeting analyzer module 120 then filters meeting entries from the meeting entries 114 that temporally intersect with windows of time when the user 103 indicated that he or she was unavailable. Hence, if the first meeting entry 302 represents a meeting that occurred when the user 103 was out of the office, the meeting analyzer module 120 filters such meeting entry from the meeting entries 114. In addition, for each remaining (unfiltered) meeting entry, the meeting analyzer module 120 extracts the location string therefrom and ascertains whether the location string refers to a physical location. If the meeting analyzer module 120 determines that the location string does not refer to a physical location, the meeting analyzer module 120 filters the meeting entry from the meeting entries 114. Further, for each remaining (unfiltered) meeting entry, the meeting analyzer module 120 can ascertain whether the location string of the meeting entry comprises a geolocation, such as a street address and/or latitude longitude coordinates. If the meeting analyzer module 120 determines that the location string comprises the geolocation, the meeting analyzer module 120 can filter the meeting entry from the meeting entries 114. Moreover, for each remaining (unfiltered) meeting entry, the meeting analyzer module 120 can ascertain whether the location string is already mapped to a geolocation in the mappings 116. If the meeting analyzer module 120 determines that the location string is already mapped to a geolocation in the mappings 116, the meeting analyzer module 120 can filter the meeting entry from the meeting entries 114. Remaining meeting entries are those that have location strings for which geolocations are desirably inferred for the user 103.

In the example depicted in FIG. 3, unfiltered meeting entries from the meeting entries 114 output by the meeting analyzer module 120 include the first meeting entry 302 and a second meeting entry 306, wherein the first meeting entry 302 has a start time tₑ, an end time tf, and a first location string, and further wherein the second meeting entry 306 has a start time t_{g}, an end time tₕ, and a second location string.

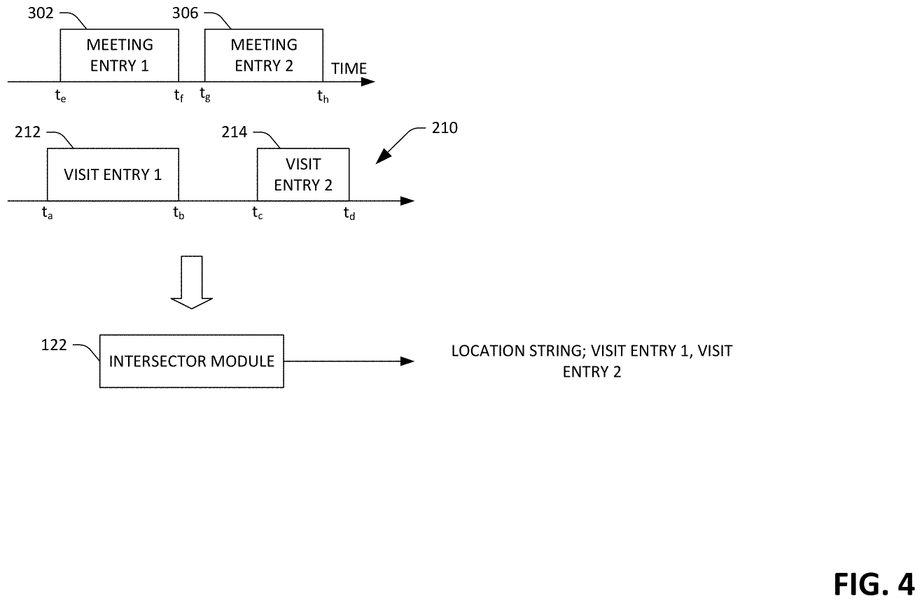

Referring now to FIG. 4, a schematic depicting exemplary operation of the intersector module 122 is presented. The intersector module 122 receives the meeting entries 302 and 306 output by the meeting analyzer module 120 and further receives the location diary 210 output by the location diary generator module 118. The intersector module 122 selects a meeting entry from the unfiltered meeting entries and ascertains whether one or more visit entries temporally overlap with the meeting entry. For example, the intersector module 122 can select the first meeting entry 302 and identify one or more visit entries that temporally overlap with the time window between tₑ and t_{f} (the start time and the end time of the first meeting entry 302). In the example shown in FIG. 4, the first visit entry 212 temporally overlaps with the first meeting entry 302, and hence the intersector module 122 can map the first meeting entry 302 to the first visit entry 212. Similarly, the intersector module 122 can select the second meeting entry 304 and identify one or more visit entries that temporally overlap with the time window between t_{g} and th (the start time and the end time of the second meeting entry 304). In the example shown in FIG. 4, the second visit entry 214 temporally overlaps with the second meeting entry 306, and hence the intersector module 122 can map the second meeting entry 306 to the second visit entry 214. It is possible for multiple visit entries to temporally overlap one meeting entry, in which case the intersector module 122 maps each of the visit entries to the meeting entries.

Responsive to the intersector module 122 mapping meeting entries to visit entries, the intersector module 122 can map the location strings of the meeting entries to visit entries. In an example, the first meeting entry 302 and the second meeting entry 306 may have the same location string; the intersector module 122 maps the location string to the first visit entry 212 and the second visit entry 214, as illustrated in FIG. 4. Accordingly, for each location string in the unfiltered meeting entries, the intersector module 122 maps visit entries that temporally overlap with meeting entries that include the location string.

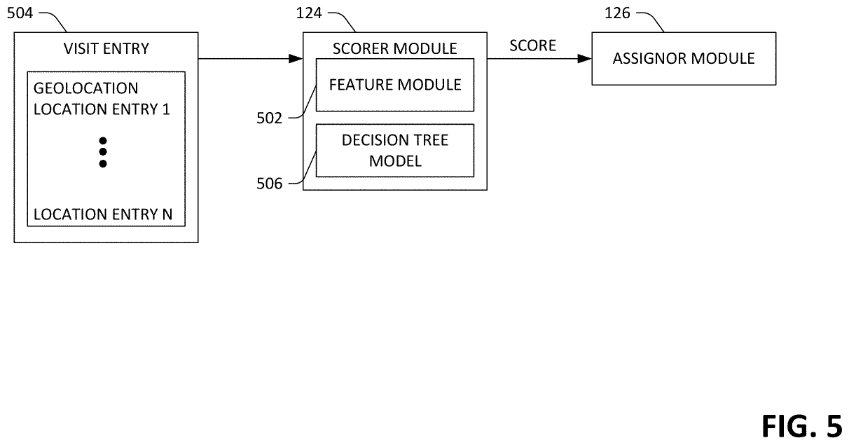

Now referring to FIG. 5, a schematic illustrating exemplary operation of the scorer module 124 is illustrated. In an exemplary embodiment, the scorer module 124, when there are multiple visits mapped to a location string, can select a visit entry from the multiple visit entries based upon features of the visit entry. For instance, the scorer module 124 can select a most recent visit entry (e.g., the visit entry with the most recent end time). In another example, the scorer module 124 can select the visit entry with the longest duration. In yet another example, the scorer module 124 can select the visit entry that most closely aligns in time to a meeting entry that includes the location string. In yet another example, the scorer module 124 can receive each visit entry that is mapped to the location string and can generate a score for each visit entry.

The scorer module 124 includes a feature module 502, wherein the feature module 502 receives a visit entry 504 and generates values for features of the visit entry 504. Exemplary features for which values can be generated by the feature module 502 include but are not limited to: 1) coverage; 2) cluster density; 3) number of observations; 4) visit duration; 5) semantic label; 6) last observation time; and 7) cluster radius. Coverage refers to an amount of temporal overlap between the visit entry and the meeting entry that is mapped to the visit entry 504. Cluster density refers to a total number of location entries in the visit entry 504. Number of observations refers to a number of location entries in the visit entry that temporally overlap with the meeting entry that is mapped to the visit entry 504. Visit duration refers to a total time duration of the visit entry 504. A semantic label refers to a label that may be assigned to the geolocation of the visit entry 504, such as “home” or “work”. Last observation time is a time of a timestamp of the latest location entry in the visit entry 504. Cluster radius is a spatial radius of the location entries in the visit entry 504.

The scorer module 124 generates a score that is indicative of a confidence that the location string refers to the geolocation of the visit entry 504 for the user 103, wherein the scorer module 124 generates the score based upon the feature values output by the feature module 502. In an exemplary embodiment, the scorer module 124 can include a decision tree model 506, wherein the decision tree model 504 can be a gradient-boosted decision tree model. The decision tree model 506 can be trained based upon labeled training data.

The assignor module 126 receives the score for the visit entry 504 output by the scorer module 124 and compares the score to a predefined threshold. When the score is below the predefined threshold, the assignor module 126 fails to map the geolocation of the visit entry 504 to the location string in the mappings 116. When the assignor module 126 ascertains that the score is above the predefined threshold, the assignor module 126 can update the mappings 116 to include a mapping between the location string and the geolocation of the visit entry 504. In an example, the predefined threshold can be 0.85, and decision tree model 506 can optimize for a precision of 0.9+ with recall of 0.4+.

Once the location string is mapped to the geolocation of the visit entry 504 in the mappings 116, the computing system 104 can generate and transmit TTL notifications to one or more computing devices of the user 103. With more particularity, the message generator module 128 can search meeting entries (that represent meetings that are to occur in the future) of the electronic calendar application for the location string in the mappings 116. When a meeting entry includes the location string, the message generator module 128, in an example, can assign the geolocation that is mapped to the location string in the mappings 116 to the meeting entry. The message generator module 128 can receive a location entry most recently output by the mobile computing device 102 (e.g., the current location of the mobile computing device 102) and can ascertain an expected amount of time it will take for the user 103 of the mobile computing device 102 to depart his or her current location to reach the geolocation assigned to the meeting entry. Based upon a start time of the meeting entry, current location of the user 103, the geolocation assigned to the meeting entry, and the expected travel time between the current location of the user 103 and the geolocation assigned to the meeting entry, the message generator module 128 can transmit a TTL notification to the mobile computing device 102 of the user 103.

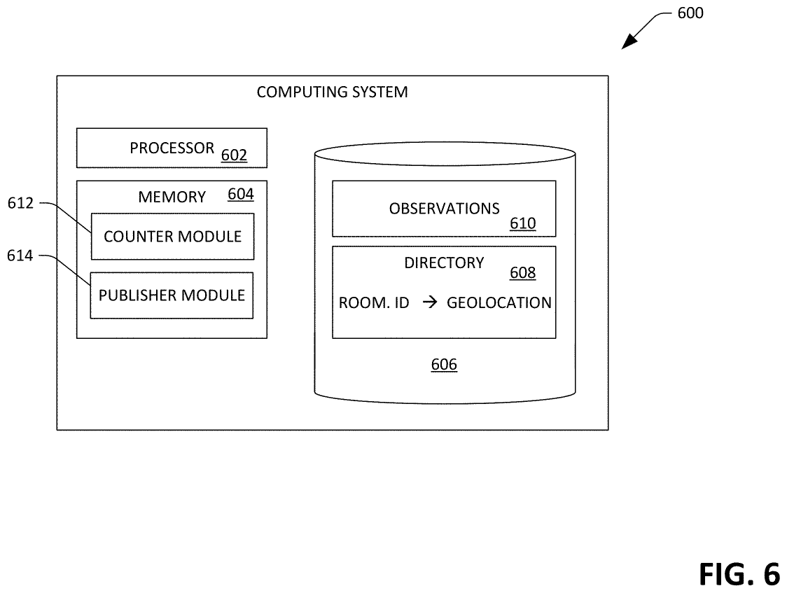

Referring now to FIG. 6, an exemplary computing system 600 that can assign a geolocation to a location string in a global directory for an enterprise is illustrated. The mapping of a geolocation to a location string performed by the assignor module 126 may be user-specific. For example, for meetings that include the location string “Building 12, Room 5154”, the user 103 may call into such meetings from his or her home. Hence, the assignor module 126 may ascertain that the location string “Building 12, Room 5154” is to be mapped to a street address of the home of the user 103 and/or latitude/longitude coordinates that correspond to the home of the user 103. The home of the user 103, however, is not the physical location of “Building 12, Room 5154.”

The computing system 600 is configured to map a geolocation to a location string in meeting entries of users of an enterprise globally in an enterprise directory. The computing system 600 includes a processor 602 and memory 604, wherein the memory 604 includes instructions that are executed by the processor 602. The computing system 600 also includes a data store 606, wherein the data store 606 includes an enterprise directory 608 that can map location strings (such as room identifiers) in an enterprise to geolocations (such as street addresses or latitude/longitude coordinates). The data store 606 also includes observations 610 for a location string, wherein each observation can include a user identifier, the location string, and a geolocation mapped to the location string in mappings generated for individual users in the enterprise (such as the mappings 116).

The memory 604 includes a counter module 612 and a publisher module 614. The counter module 612 is configured to count a number of observations that include the location string. When the number of observations that include the location string is below a threshold, a geolocation is not mapped to the location string. When the counter module 612 outputs an indication that the number of observations for the location string is at or above the predefined threshold, the publisher module 614 can ascertain whether there is sufficiently high confidence that a geolocation from one or more of the observations is to be globally mapped to the location string in the directory 608. In an exemplary embodiment, the publisher module 614 can cluster the observations 610 that include the location string based upon geolocations in the observations 610, such that spatially proximate geolocations are clustered together. When several clusters are generated, the publisher module 614 can identify the cluster that includes the largest number of observations and can ascertain whether to assign a geolocation to the location string in the directory 608 based upon the number of observations in the cluster. For instance, the publisher module 614 can ascertain whether the number of observations in the cluster (with each observation corresponding to a different user) represents at least a predefined percentage (e.g., 5%) of users in an enterprise. When the publisher module 614 determines that the number of observations in the cluster represents at least the predefined percentage of users in the enterprise, the publisher module 614 can determine a geolocation based upon the geolocations of the observations in the cluster and can assign such geolocation to the location string in the directory 608. For instance, the publisher module 614 can identify a street address, can identify a centroid of geolocations in the cluster, etc. In another example, the publisher module 614 can score the cluster based upon features of the cluster, such as the number of observations in the cluster, a duration of time between a first and last observation in the cluster, etc., and can ascertain whether to assign a geolocation to the location string in the directory 608 based upon the score.

Once a geolocation is assigned to the location string (room identifier) in the directory 608, each meeting entry in an electronic calendar application of the enterprise that includes the location string is assigned the geolocation from the directory 608. The message generator module 128 can generate TTL notifications to users based upon the assignation of the geolocation to the location string in the directory 608.

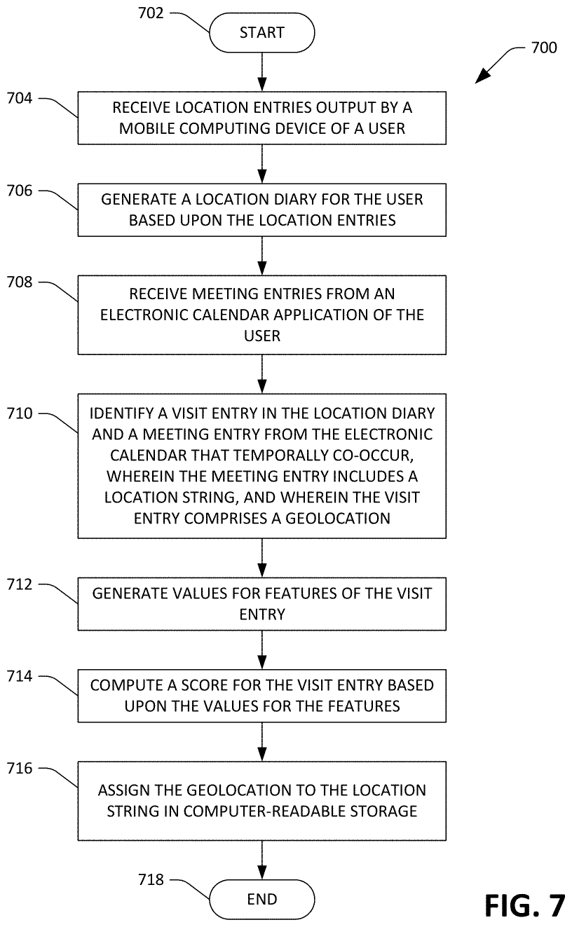

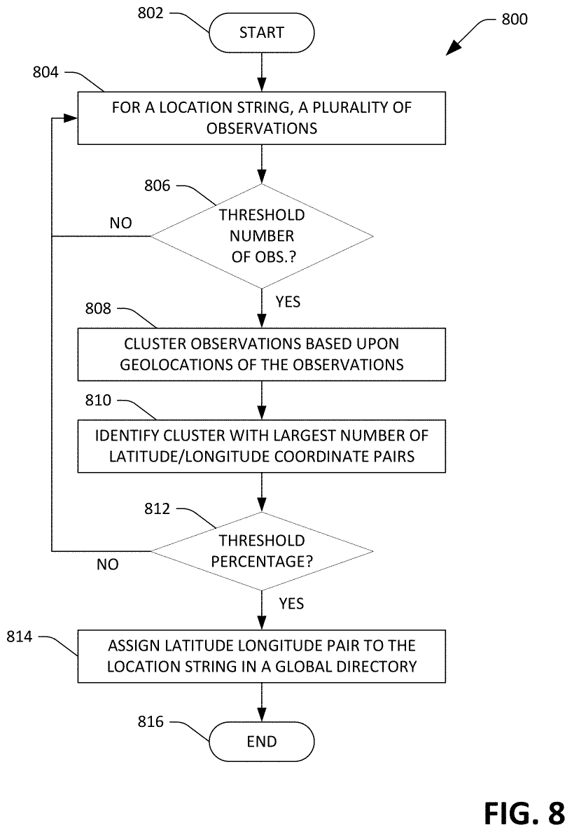

FIGS. 7 and 8 illustrate exemplary methodologies relating to mapping geolocations to location strings extracted from meeting entries of electronic calendar applications. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to solely to FIG. 7, a flow diagram illustrating an exemplary methodology 700 for assigning a geolocation to a location string extracted from a meeting entry of an electronic calendar application is illustrated. The methodology 700 starts at 702, and at 704 location entries output by a mobile computing device of a user are received. At 706, a location diary for the user is generated based upon the location entries, wherein the location diary includes a time ordered sequence of visit entries, with each visit entry representing a visit of the user to a respective geolocation. As described previously, the visit entries can be generated by clustering the received location entries into a plurality of clusters.

At 708, meeting entries from an electronic calendar application of the user are received, wherein the meeting entries correspond to meetings that have occurred in the past, and further wherein the meeting entries indicate that the user attended meetings represented by the meeting entries.

At 710, a visit entry in the location diary and a meeting entry from the electronic calendar are identified, wherein the visit entry and the meeting entry temporally overlap. The meeting entry includes a location string and the visit entry comprises a geolocation that can be potentially assigned to the location string. At 712, values for features of a cluster of location entries included in the visit entry are generated. At 714, a score is computed for the visit entry based upon the values for the features and at 716, the geolocation of the visit entry is assigned to the location string in computer-readable storage when the score for the visit entry is above a predefined threshold. Subsequently, a TTL notification can be transmitted to a computing device of the user based upon: 1) the location string occurring in a meeting entry that represents a meeting that is to occur in the future; and 2) the assignation of the geolocation to the location string. The methodology 700 completes at 718.

Now referring to FIG. 8, a flow diagram illustrating an exemplary methodology 800 for assigning a geolocation to a location string in an enterprise directory is illustrated. The methodology 800 starts at 802, and at 804 several observations for a location string are received, wherein an observation includes the location string and a geolocation that has been mapped to the location string for a user. At 806, a determination is made as to whether there are a threshold number of observations in the received observations. When the observations fail to include the threshold number of observations, the methodology returns to 804 and observations for a different location string are received. When there are a threshold number of the observations as determined at 806, the observations are clustered based upon the geolocations in the observations at 808. At 810, a cluster with a largest number of observations is identified, and at 812 a determination is made as to whether a threshold number of observations are included the cluster. When it is determined at 812 that the cluster fails to include the threshold number of observations, the methodology returns to 804. When it is determined at 812 that the cluster includes the threshold number of observations, at 814 a geolocation is determined based upon the geolocations in the observation and the geolocation is assigned to the location string in an enterprise directory. The methodology 800 completes in at 816.

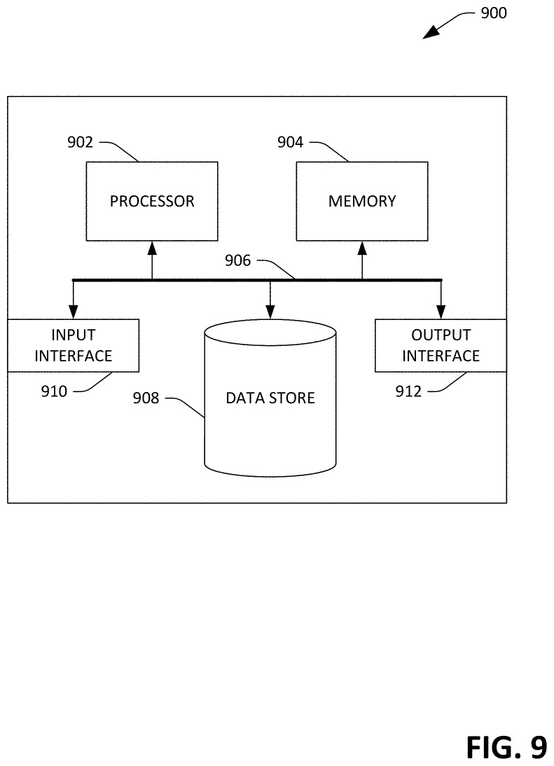

Referring now to FIG. 9, a high-level illustration of an exemplary computing device 900 that can be used in accordance with the systems and methodologies disclosed herein is illustrated. For instance, the computing device 900 may be used in a system that is configured to map geolocations to location strings extracted from meeting entries for a user. By way of another example, the computing device 900 can be used in a system that is configured to map geolocations to location strings in a directory for an enterprise. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store location entries, visit entries, meeting entries, mappings between geolocations and location strings, etc.

The computing device 900 additionally includes a data store 908 that is accessible by the processor 902 by way of the system bus 906. The data store 908 may include executable instructions, location entries, meeting entries, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
generating a visit entry based upon location entries generated by a location sensor of a mobile computing device of a user, wherein the visit entry comprises:
a geolocation of a visit of the user represented by the visit entry;
a start time of the visit; and
an end time of the visit;
mapping a meeting entry of an electronic calendar of a user to the visit entry based upon the meeting entry and the visit entry temporally overlapping with one another, wherein the meeting entry comprises a location string, a meeting start time, and a meeting end time, wherein the meeting entry is representative of a meeting attended by the user, wherein the location string comprises text that is descriptive of a location of the meeting; and
subsequent to mapping the meeting entry to the visit entry, assigning the geolocation to a second meeting entry in the electronic calendar of the user, wherein the geolocation is assigned to the second meeting entry based upon the second electronic meeting entry comprising the location string.

2. The computing system of claim 1, the acts further comprising:
receiving a location entry generated by the location sensor of the mobile computing device, the location entry indicative of a current location of the mobile computing device; and
transmitting an electronic message to the mobile computing device based upon the second meeting entry being assigned the geolocation, the electronic message providing a recommended time that the user is to leave the current location to reach a location of a second meeting represented by the second meeting entry.

3. The computing system of claim 1, wherein the geolocation is a latitude/longitude coordinate pair, wherein the location entries comprise respective latitude/longitude coordinate pairs, the acts further comprising computing the latitude/longitude coordinate pair based upon the respective latitude/longitude coordinate pairs of the location entries.

4. The computing system of claim 1, wherein the geolocation is a street address, the acts further comprising identifying the street address based upon latitude/longitude coordinate pairs in the location entries generated by the location sensor.

5. The computing system of claim 1, the acts further comprising:
clustering the location entries into a plurality of clusters, wherein each cluster includes one or more of the location entries generated by the location sensor of the mobile computing device, wherein each location entry comprises a respective latitude/longitude pair, and further wherein each location entry comprises a respective timestamp that is indicative of when the location sensor generated the latitude/longitude pair to which the timestamp is assigned, wherein generating the visit entry comprises:
for a cluster in the plurality of clusters:
computing the geolocation based upon latitude/longitude pairs of respective location entries included in the cluster;
assigning an earliest timestamp in the cluster as the start time of the visit; and
assigning a latest timestamp in the cluster as the end time of the visit.

6. The computing system of claim 1, the acts further comprising:
generating a set of features for the visit entry;
providing the set of features to a scoring function, wherein the scoring function outputs a score for the visit entry; and
determining that the score for the visit entry is above a predefined threshold score, wherein the geolocation is assigned to the second meeting entry based upon the score for the visit entry being above the predefined threshold score.

7. The computing system of claim 1, wherein the location string identifies a conference room identified in an enterprise directory, the acts further comprising:
mapping the geolocation to the conference room in the enterprise directory;
subsequent to mapping the geolocation to the conference room in the enterprise directory, receiving an indication that a third meeting entry has been created, wherein the third meeting entry comprises a start time, an identity of a second user, and the location string, wherein the third meeting entry represents a third meeting that is to occur in the conference room; and
transmitting an electronic message to a computing device of the second user prior to the start time of the third meeting entry, wherein the electronic message comprises a recommended time that the second user is to leave a current location of the second user for the conference room, wherein the electronic message is based upon the mapping of the geolocation to the conference room in the enterprise directory.

8. The computing system of claim 7, wherein the geolocation is mapped to the conference room in the enterprise directory based upon a number of users in the enterprise who have had geolocations mapped to the location string.

9. A method executed by a processor of a computing device, the method comprising:
generating a location diary for a user based upon location entries output by a sensor of a mobile computing device of the user, wherein the location diary comprises a chronologically ordered sequence of visit entries that represent visits of the user to places, wherein a visit entry comprises:
a geolocation;
a start time; and
an end time;
identifying a meeting entry from an electronic calendar application of the user, wherein the meeting entry temporally intersects the visit entry in the location diary, and further wherein the meeting entry represents a meeting that previously occurred;
extracting a location string from the meeting entry, the location string identifies a conference room in which the meeting was scheduled to occur; and
mapping, in computer-readable storage, the geolocation of the visit entry to the location string extracted from the meeting entry based upon the meeting entry temporally intersecting the visit entry.

10. The method of claim 9, wherein the location string is a name of the conference room.

11. The method of claim 9, wherein the geolocation is a latitude/longitude coordinate pair.

12. The method of claim 9, wherein generating the location diary comprises:
clustering the location entries into a plurality of clusters, wherein each visit entry in the location diary corresponds to a respective cluster in the plurality of clusters.

13. The method of claim 9, further comprising:
subsequent to mapping the geolocation of the visit to the location string, identifying a second meeting entry from the electronic calendar application of the user, wherein the second meeting entry represents a second meeting that is to occur in the future and includes a meeting start time and the location string;
identifying a current location of the user based upon a location entry generated by the mobile computing device of the user; and
transmitting an electronic message to the mobile computing device of the user, the electronic message comprises a recommendation as to when the user is to depart the current location of the user to reach the geolocation.

14. The method of claim 9, further comprising:
subsequent to mapping the geolocation of the visit to the location string, identifying a second meeting entry from the electronic calendar application of a second user, wherein the second meeting entry represents a second meeting that is to occur in the future and includes a meeting start time and the location string;
identifying a current location of the second user based upon a location entry generated by a second mobile computing device of the second user; and
transmitting an electronic message to the second mobile computing device of the second user, the electronic message comprises a recommendation as to when the second user is to depart the current location of the second user to reach the geolocation.

15. The method of claim 9, further comprising:
generating a set of feature values for the visit entry;
providing the set of feature values to a scoring function, wherein the scoring function outputs a score for the visit entry; and
determining that the score for the visit entry is above a predefined threshold score, wherein the geolocation is mapped to the location string based upon the score for the visit entry being above the predefined threshold score.

16. The method of claim 9, wherein the geolocation is a latitude/longitude coordinate pair, the method further comprising:
updating an enterprise directory based upon the mapping of the geolocation of the visit entry to the location string, wherein the enterprise directory, when updated, indicates that the conference room corresponds to the latitude/longitude pair.

17. A computer-readable storage medium comprising instructions that, when executed by a processor of a computing system, cause the processor to perform acts comprising:
generating a visit entry based upon location entries generated by a location sensor of a mobile computing device of a user, wherein the visit entry comprises:
location data that identifies a location of a visit of the user represented by the visit entry;
a start time of the visit; and
an end time of the visit;
mapping a meeting entry of an electronic calendar of a user to the visit entry based upon the meeting entry and the visit entry temporally overlapping with one another, wherein the meeting entry comprises a location string, a meeting start time, and a meeting end time, wherein the meeting entry is representative of a meeting attended by the user, wherein the location string comprises text that is descriptive of a location of the meeting; and
subsequent to mapping the meeting entry to the visit entry, assigning the geolocation to a second meeting entry in the electronic calendar of the user, wherein the geolocation is assigned to the second meeting entry based upon the second electronic meeting entry comprising the location string.

18. The computer-readable storage medium of claim 17, the acts further comprising:
receiving a location entry generated by the location sensor of the mobile computing device, the location entry indicative of a current location of the mobile computing device; and
transmitting an electronic message to the mobile computing device, the electronic message providing a recommended time that the user is to leave the current location to reach the geolocation.

19. The computer-readable storage medium of claim 17, wherein the geolocation is a latitude/longitude coordinate pair, wherein the location entries comprise respective latitude/longitude coordinate pairs, the acts further comprising computing the latitude/longitude coordinate pair based upon the respective latitude/longitude coordinate pairs of the location entries.

20. The computer-readable storage medium of claim 17, wherein the geolocation is a street address, the acts further comprising identifying the street address based upon latitude/longitude coordinate pairs in the location entries generated by the location sensor.
